(19) United States
(12) Patent Application Publication
(10) Pub. No.: US 2026/0226713 A1
(43) Pub. Date: Aug. 6, 2026

(54) Method Of Controlling A Powertrain

(71) Applicant: Caterpillar SARL, Geneva (CH)

(72) Inventors: Niall Hugh McNamee, Raleigh, NC (US); Paul John Cairns, Groby, Leicestershire (GB); Arick Bakken, Raleigh, NC (US); James William Haslam, Ashbourne, Derbyshire (GB)

(21) Appl. No.: 19/149,673

(22) PCT Filed: Jan. 29, 2024
(86) PCT No.: PCT/EP2024/025054

§ 371 Date: Jul. 21, 2025

(30) Foreign Application Priority Data
Feb. 3, 2023 (GB) 2301573.8

(51) Int. Cl. E02F 9/22

(52) U.S. Cl. CPC E02F 9/2246

(57) ABSTRACT

A method of controlling a torque output of a powertrain of a work vehicle in response to a demanded torque output for the powertrain is provided. The method comprises determining a change in the torque output of the powertrain in response to the demanded torque output based on a torque rate of change constraint. The method also comprises determining a change in the power output of the powertrain based on the determined change in the torque output of the powertrain. If the determined change in the power output of the powertrain exceeds a power change threshold of the powertrain, the determined change in the torque output of the powertrain is updated based on a power rate of change constraint of the powertrain. The torque output of the powertrain is controlled based on the determined change in the torque output.

### FIELD OF THE DISCLOSURE

This disclosure relates powertrains. In particular, this disclosure relates to the control of a torque output of a powertrain.

### BACKGROUND

A work vehicle may be used for a variety of applications on a work site. Examples of work vehicles include excavators, bull dozers, mini-excavators, loaders including tracked loaders and wheel loaders, and the like. Such work vehicles may be used to perform a variety of operations including driving, pushing, and digging. In order to provide the power required to perform the desired operation, the work vehicle comprises a powertrain. The powertrain may be used to supply mechanical power in the form of a torque to the mechanically powered components of the work vehicle. As such, the powertrain may be used to provide a torque output for work operations (such as digging and pushing) and a torque output for driving operations. The mechanically powered components of the work vehicle may comprise components suitable for driving operations, work operations, and/or both driving and work operations. Mechanically powered components of a work vehicle may include wheels, axels, digging tools, and/or other mechanically powered components for driving and/or work operations.

Various types of powertrains are known to the skilled person. For example, a powertrain of a work vehicle may comprise an internal combustion engine. Powertrains comprising one or more electric motors are also known to the skilled person.

U.S. Pat. No. 10,407,864 discloses a work implement requirement determination unit which determines a work implement required horsepower on the basis of an operation amount of a work implement operating member and a hydraulic pressure of a hydraulic pump. A transmission requirement determination unit determines a transmission required horsepower on the basis of a vehicle speed and the operation amount of the accelerator operating member. An engine requirement determination unit determines an engine required horsepower on the basis of the work implement required horsepower and the transmission required horsepower. The required throttle determination unit determines a required throttle value based on an engine requirement.

Against this background, this disclosure seeks to provide an improved, or at least commercially relevant alternative, method of controlling a torque output of powertrain and a controller for a powertrain.

### SUMMARY OF THE DISCLOSURE

According to a first aspect of the disclosure, a method of controlling a torque output of a powertrain of a work vehicle in response to a demanded torque output for the powertrain is provided. The method comprises:
determining a change in the torque output of the powertrain in response to the demanded torque output based on a torque rate of change constraint;
determining a change in the power output of the powertrain based on the determined change in the torque output of the powertrain,
   wherein if the determined change in the power output of the powertrain exceeds a power change threshold of the powertrain, the determined change in the torque output of the powertrain is updated based on a power rate of change constraint of the powertrain; and
controlling the torque output of the powertrain based on the determined change in the torque output.

According to the method of the first aspect, the torque output of a powertrain may be controlled for a work operations and for a driving operation. For example, work operations such as digging or pushing require a relatively high amount of torque to be applied. In such operations, it is desirable for the powertrain to increase the torque output of the powertrain at a relatively high rate. Often, a torque rate of change constraint for the powertrain may be selected in order to achieve a predetermined “time to maximum torque” (i.e. the time taken by the powertrain to increase the torque output from zero to the maximum torque output of the powertrain). The torque rate of change constraint (or “time to maximum torque”) may be selected in order for the powertrain to feel responsive to an operators' input.

It will be appreciated that for digging or pushing work operations where a high torque output is required, the rate of increase of the power output of the powertrain at the start of the work operation is relatively slow.

For some other work operations, such as a driving operation, having a relatively high torque rate of change constraint results in, for example, rapid acceleration of the work vehicle from a standing start. Such rapid acceleration of a work vehicle may be undesirable for a user of the work vehicle.

Accordingly, the method of the first aspect provides a way of controlling the torque output of a powertrain of a work vehicle for a work operation and a driving operation. The present inventors have realised that it is possible to control the rate of change of torque output of a powertrain based primarily on a torque rate of change of constraint. Such a torque rate of change constraint may be selected to achieve a desired time to maximum torque for e.g. a digging or pushing operation. However, in cases where the rate of change of torque output is predicted to cause an excessive change in the power output of the powertrain (e.g. due to rapid acceleration in a driving mode), the method further limits the rate of change of the torque output of the powertrain based on a power rate of change constraint of the powertrain.

According to a second aspect of the disclosure, a controller for controlling a torque output of a powertrain of a work vehicle is provided. The controller is configured to:
obtain a demanded torque output for the powertrain;
determine a change in the torque output of the powertrain in response to the demanded torque output based on a torque rate of change constraint;
determine a change in the power output of the powertrain based on the determined change in the torque output of the powertrain,
   wherein if the determined change in the power output of the powertrain exceeds a power change threshold of the powertrain, the controller is configured to update the determined change in the torque output of the powertrain based on a power rate of change constraint of the powertrain; and
output a signal for controlling the torque output of the powertrain based on the determined change in the torque output.

It will be appreciated that the controller of the second aspect may be configured to perform the method of the first aspect and any associated advantages.

According to a third aspect of the disclosure, a powertrain for a work vehicle is provided. The powertrain may be configured to perform the method of the first aspect. The powertrain of the second aspect may comprising the controller of the second aspect or may be configured to receive the signal output from the controller for controlling the torque output of the powertrain.

According to a fourth aspect of the disclosure, a work vehicle comprising a powertrain according to the third aspect and a controller according to the fourth aspect is provided.

According to a fifth aspect of the disclosure, a computer program comprising instructions to cause the controller of the second aspect to perform the method of the first aspect is provided.

According to a sixth aspect of the disclosure, a computer-readable medium having stored thereon the computer program of the fifth aspect is provided.

### BRIEF DESCRIPTION OF THE DRAWINGS

A specific embodiment of the disclosure will now be described, by way of example only, with reference to the accompanying drawings in which:

FIG. 1 is a schematic diagram of a work vehicle according to this disclosure;

FIG. 2 shows a block diagram of a method of controlling a torque output of a powertrain of a work vehicle in response to a demanded torque output for the powertrain;

FIG. 3 is a graph of a user interface demand received by a controller;

FIGS. 4a, 4b, and 4c show the variation in the demanded torque output D(t), first proposed torque output X(t), and torque output T(t) respectively over time in response to the user interface demand shown in FIG. 3;

FIGS. 5a, 5b, and 5c show graphs of the variation in the powertrain speed ω(t), the first proposed power output P_{Proposed1}(t), and the second proposed power output P_{Proposed2}(t) in response to the user interface demand shown in FIG. 3;

FIGS. 6a, 6b and 6c show graphs of the first proposed torque output X(t), second proposed torque output Y(t), and the torque output T(t) for the powertrain 124 respectively in response to the user interface demand shown in FIG. 3;

FIG. 7a shows a graph of the torque output T(t) of the powertrain in response to the use interface demand shown in FIG. 3;

FIG. 7b shows a graph indicating the periods of time where the rate of change of the demanded torque output of the powertrain exceeds a rate of change based on the torque rate of change constraint (C_{T}); and

FIG. 7c shows a graph indicating the time periods where the rate of change of the torque output is limited by a power rate of change constraint (C_{P}).

### DETAILED DESCRIPTION

According to an embodiment of this disclosure, a work vehicle 120 is provided.

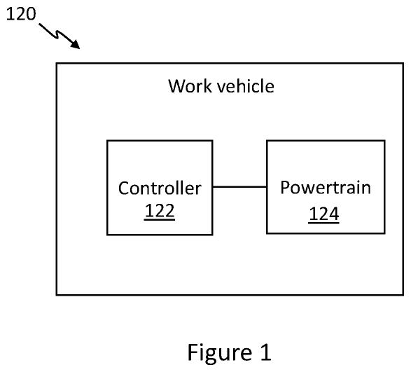

FIG. 1 shows a schematic block diagram of a work vehicle 120 according to an embodiment of the disclosure. The work vehicle 120 comprises a controller 122 and a powertrain 124.

In some embodiments, the work vehicle 120 may be an electric work vehicle. In some embodiments, the work vehicle 120 may be an internal combustion engine work vehicle. The work vehicle 120 may comprise one or more mechanically powered components (not shown in FIG. 1) suitable for driving operations, work operations, and/or both driving and work operations. The mechanically powered components of a work vehicle 120 may include wheels, axels, digging tools, and/or other mechanically powered components for driving and/or work operations.

The powertrain 124 may be used to supply mechanical power in the form of a torque to the mechanically powered components of the work vehicle 120. The powertrain 124 may comprise a prime mover and a drivetrain. In embodiments where the work vehicle 120 is an electric work vehicle, the prime mover may be an electric motor. In embodiments where the work vehicle 120 is an internal combustion engine work vehicle, the prime mover may be an internal combustion engine. The drivetrain may comprise one or more mechanically powered components, for example a transmission, driveshafts, differential, axles, and/or the like. In this way, the powertrain 124 may be used to supply mechanical power to wheels, axels, digging tools, and/or other mechanically powered components for driving and/or work operations.

The driving operations may include using the mechanically powered components to move the work vehicle 120. The work operations may include pushing operations and/or pulling operations and/or digging operations. In some examples, the same mechanically powered components may be used for both driving and work operations. For example, if the work operations include pushing and/or pulling operations, the same mechanically powered components may be used for both driving and work operations. In some examples, the mechanically powered components may include components which are used with either work or driving operations.

As will be understood by those skilled in the art, the torque output requirements for driving operations may be different to the torque output requirements for work operations. For example, the torque output requirements for driving and work operations may be different. For example, during a work operation a relatively large changes in torque may be desired over a relatively short timescale. As such, for some operations of a work vehicle 120, such as a work operation, it is desirable to have a relatively high rate of change of torque output. It will be appreciated that the maximum rate of change of torque (i.e. a torque rate of change constraint) may be limited by operational requirement of the powertrain and/or work vehicle. As such, the maximum rate of change of torque may be selected to achieve a desired “time to maximum torque” from zero applied torque, in order to provide the desired functionality, whilst also allowing the work vehicle to operate within specified operational limits.

While a maximum rate of change of torque may be provided for a work operation, such a maximum rate of change of torque may not be desirable for a driving operation. For example, a maximum rate of change of torque desirable for a work operation may result in excessive acceleration if when for a driving operation. Excessive acceleration of the work vehicle 120 may cause driver discomfort, and/or reduce the handling of the work vehicle 120. As such, for some other operations of a work vehicle 120, such as a driving operation, it may be desirable to provide a lower maximum rate of change of torque, than the maximum rate of change of torque allowable during a work operation.

The controller 122 is configured to obtain a demanded torque output for the powertrain 124 and to output a signal for controlling a torque output of the powertrain 124 based on a determined change in the torque output. As will be explained further below, the determined change in the torque output may be determined by the controller 122 by carrying out one or more steps. The demanded torque output may be determined by the controller based on an input from a user interface (not shown) of the work vehicle 120. For example, a user may provide an input from a user interface such as a pedal, a lever, or any other such device, wherein the controller (e.g. Engine Control Unit) is configured to determine a demanded torque output for the powertrain 124 based on the user interface input. The controller 122 may comprise an electronic control unit, for example an engine control unit (ECU).

In embodiments where the work vehicle 120 is an electric work vehicle, the work vehicle 120 may comprise an electric motor or any such device for converting electrical power into mechanical power. As will be appreciated by those skilled in the art, back electromotive force (emf) may reduce the torque of an electric motor. As will also be appreciated by those skilled in the art, back emf is dependent on and increases with the speed of the electric motor. As such, an electric motor may output a so-called instantaneous torque when the electric motor is operated at low speeds. As will be appreciated by those skilled in the art, an electric motor may accordingly provide relatively high rates of change in torque output, which may be particularly well suited for work operations using the work vehicle 120. However, such relatively rates of change in torque output may result in excessive acceleration if used for a driving operation. Thus, in embodiments where work vehicle 120 is an electric work vehicle, it may be desirable to apply torque rate of change constraints depending on whether the electric work vehicle is performing a driving operation or a work operation.

Next, a method 200 of controlling a torque output of a powertrain 124 of a work vehicle 120 in response to a demanded torque output of the powertrain 124 will be described. The method 200 may be performed by the work vehicle 120 of FIG. 1. In some embodiments, the controller 122 may perform a method 200 for controlling a torque output of a powertrain 124 of a work vehicle 120. In some examples, the method 200 is a method of controlling a torque output of a powertrain 124 of an electric work vehicle.

For the purpose of explaining the present method 200, the controller 122 may be configured to calculate the torque output T(t) for a timestep t=0, 1, 2, 3, 4, 5 . . . etc, where t is a positive integer. Each timestep t may correspond to a time interval (Δt) of a predetermined duration. For example the time interval between each timestep may about 0.01 s, or any other suitable timestep of sufficient frequency to provide sufficient responsiveness of the controller 122/work vehicle 120. As such, the following explanation of the embodiment assumes that the time interval between each timestep is constant. Of course in some embodiments, the duration of the timestep may vary. For example, the duration of the timestep may vary based on computational requirements, such as the usage of a processing unit associated with the controller 122. Where the duration of the timestep may be variable, the skilled person will appreciate that the various rates described below may be calculated based on the duration of the time interval.

In some embodiments, the controller 122 may be configured to obtain the demanded torque output (D(t)) for the powertrain 124 for a given timestep. The demanded torque output (D(t)) may be received from a user interface. For example, a user may provide a demanded torque via a pedal, a lever, or any other such device for providing a demanded torque to the controller 122.

In a first step 230, a change in the torque output of the powertrain 124 is determined in response to the demanded torque output based on a torque rate of change constraint 235. In this way, the change in the torque output of the powertrain 124 may be limited by the torque rate of change constraint 235.

For example, in the first step 230, the change in torque output of the powertrain 124 may be determined based on a current torque output T_{Current}(t) of the powertrain 124 for the timestep t, the demanded torque output (D(t) and the torque rate of change constraint C_{T}. In some embodiments, the current torque output T_{Current}(t) of the powertrain 124 for the timestep t may be provided by the controller 122. In some embodiments, the current torque output T_{Current}(t) of the powertrain may be considered to be the torque output of the powertrain 124 (T(t)) calculated for the preceding timestep.

It will be appreciated that the demanded torque output D(t) may change over time. For a given timestep t, the demanded change in torque output of the powertrain ΔT(t) may be defined by the difference between the demanded torque output D(t) and the current torque output T_{Current}(t).

As will be appreciated by those skilled in the art, the difference between the demanded torque output D(t) and the current torque output T_{Current}(t) may be greater than an allowable change in torque for a given timestep. As such, the change in the torque output ΔT(t) may be limited by a torque rate of change constraint C_{T}. The torque rate of change constraint may define a maximum allowable change in the torque output of the powertrain 124 for the timestep Δt. As such, where the magnitude of the difference between the demanded torque output D(t) and the current torque output T_{Current}(t) is greater than the torque rate of change constraint C_{T}, the change in torque output ΔT(t) is limited to the torque rate of change constraint of the appropriate sign.

$$\begin{matrix}Thus , if \vert Δ T ( t ) \vert \leq {C}_{T} : \\ Δ T ( t ) = D ( t ) - {T}_{Current} ( t ) ; \\ if Δ T ( t ) > {C}_{T} : \\ Δ T ( t ) = {C}_{T} ; and \\ if Δ T ( t ) < - {C}_{T} : \\ Δ T ( t ) = - {C}_{T} .\end{matrix}$$

Thus, in effect, step 230 has the effect of determining a proposed torque output for the powertrain for the timestep t, where the first proposed torque output X(t) is equal to the combination of the current torque output T_{Current}(t) and the change in torque output ΔT(t):

$$X ( t ) = Δ T ( t ) + {T}_{Current} ( t )$$

In some embodiments, the torque rate of change constraint may be set to avoid damage to the mechanically powered components when carrying out a work operation, e.g. to avoid moving a digging tool too quickly.

In some embodiments, the torque rate of change constraint C_{T} may be configured to meet a time to maximum torque target. The time to maximum torque target may be set such that the maximum torque output is obtained sufficiently quickly for a work operation. The time to maximum torque target may be set such that the maximum torque output is not obtained too slowly. For example, the torque rate of change constraint C_{T} may be provided to prevent damage to the powertrain 124 or work vehicle 120.

In the above explanation, the same torque rate of change constraint is applied when the magnitude of the demanded torque output (D(t) increases relative to the magnitude of the current torque output T_{Current}(t), as when the magnitude of the demanded torque output D(t) decreases relative to the current torque output T_{Current}(t). In other embodiments, the a torque increase rate of change constraint C_{Tinc} may be provided when magnitude of the demanded torque output (D(t)) increases relative to the current torque output T_{Current}(t). Where the magnitude of the demanded torque output (D(t)) decreases relative to the current torque output T_{Current}(t), a torque decrease rate of change constraint C_{TDec} may be provided. In this way, the rate of change of the torque output of the powertrain 124 may be adapted to whether the magnitude of the demanded torque output is increasing or decreasing.

$$Thus , if \vert D ( t ) \vert > \vert {T}_{Current} ( t ) \vert , {C}_{T} = {C}_{Tinc} . If \vert D ( t ) \vert < \vert {T}_{current} ( t ) \vert , {C}_{T} = {C}_{Tdec} .$$

As discussed above, for some operations of a work vehicle 120, such as a work operation, it is desirable to have allow a relatively high rate of change of torque output. However, for some other operations of a work vehicle 120, such as a driving operation, the same rate of change of torque output may not be desirable, for example due to said rate of change of torque output resulting in excessive acceleration. In order to reduce or eliminate undesirable changes in the torque output of the work vehicle 120, the method 200 further checks the determined change in torque output ΔT(t) against a change in power output threshold, as discussed below.

In a second step 240, a change in a power output of the powertrain 124 is determined based on the determined change in the torque output ΔT(t) of the powertrain 124. In some embodiments, the change in the power output of the powertrain 124 may be determined by difference between a first proposed power output P_{proposed1}(t) of the powertrain 124 for the time step t, and a current power output P_{Current}(t) of the powertrain 124 for the timestep t. Represented as an equation, the change in the power output of the powertrain 124 may be determined by:

$$Δ P ( t ) = {P}_{Proposed 1} ( t ) - {P}_{Current} ( t )$$

The power values (e.g. the first proposed power output of the powertrain 124) and the current power output of the powertrain 124) may be calculated by a torque/power conversion based on a speed of the powertrain 124. In some embodiments, the powertrain 124 speed may be the angular speed ω of the motor or a related quantity which reflects the power output of the powertrain 124. In some examples, the powertrain 124 speed may be the speed of the work vehicle 120 or a related value. For examples, the torque/power conversion may be calculated using the equation:

$$P = T ω$$

where P is a power value, T is a torque value and w is a speed. For example, P may be the current power output of the powertrain 124, T may be the current torque output of the powertrain 124 and w may be the angular speed of the motor. As another example, P may be the first proposed power output of the powertrain 124, T may be the first proposed torque output of the powertrain 124 and ω may be the angular speed of the motor. As will be appreciated by those skilled in the art, ω be any suitable quantity related to the powertrain 124 speed provided all conversions are made using the same quantity related to the powertrain 124 speed.

In a third step 250, the determined change in the power output of the powertrain 124 is evaluated. Specifically, it is determined whether ΔP exceeds a power change threshold ΔP_{threshold} of the powertrain 124. It will be appreciated that the power change threshold ΔP_{threshold} is effectively a threshold for the rate of change of the power output of the powertrain 124. That is to say, in some embodiments where the time interval of the timestep is not constant, the power change threshold ΔP_{threshold} may take into account the duration of the timestep.

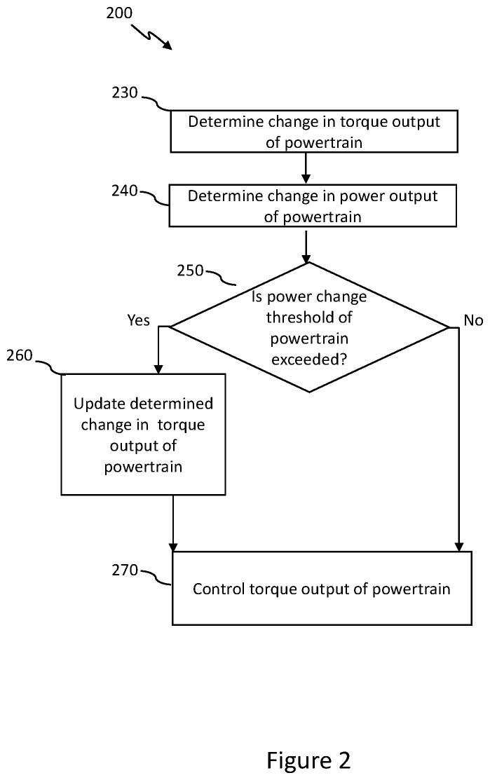

If the magnitude of ΔP is less than the power change threshold (i.e.—ΔP_{threshold}<ΔP<ΔP_{threshold}), the method does not further modify the previously proposed torque output for the powertrain X(t). As such, where—ΔP_{threshold}<ΔP<ΔP_{threshold}, the method 200 shown in FIG. 2 proceeds to step 270 and the controller outputs the proposed torque output X(t) as the torque output T(t) for the powertrain for timestep t (see step 270).

Where the magnitude of ΔP exceeds the power change threshold ΔP threshold, the method 200 proceeds to step 260 as shown in FIG. 2, as further discussed below.

In some embodiments, the power change threshold ΔP threshold may be configured to meet a maximum acceleration target. The maximum acceleration target may be configured to prevent or reduce excessive acceleration, for example when the work vehicle is performing a driving operation. In some examples, the maximum acceleration target may provide a torque output suitable for driving operations.

In the above explanation of step 250, the same power change threshold is applied when the magnitude of the proposed power output P_{Proposed 1}(t) increases relative to the magnitude of the current power output P_{Current}(t), as when the magnitude of the proposed power output P_{Proposed 1}(t) decreases relative to the current power output P_{Current}(t). In other embodiments, a power increase threshold ΔP_{ThresholdINC} may be provided when magnitude of the proposed power output increases relative to the current power output P_{Current}(t). Where the magnitude of the proposed power output P_{Proposed 1}(t) decreases relative to the current power output P_{Current}(t), a power decrease threshold ΔP_{ThresholdDEC} may be provided. In this way, the power change threshold of the controller 122 may be adapted to whether the magnitude of the demanded torque output is increasing or decreasing.

$$Thus , if \vert {P}_{Proposed 1} ( t ) \vert > \vert {P}_{Current} ( t ) \vert , Δ {P}_{threshold} = Δ {P}_{ThresholdINC .} If \vert {P}_{Proposed 1} ( t ) \vert < \vert {P}_{Current} ( T ) \vert , Δ {P}_{threshold} = Δ {P}_{ThresholdDEC} .$$

In the fourth step 260 of method 200, the determined change in the torque output ΔT(t) is updated based on a power rate of change constraint of the powertrain 124.

In some embodiments, the power rate of change constraint C_{P} may be a maximum allowable change in power for the timestep t (i.e. the maximum allowable change in power over time period Δt). In some embodiments, the power rate of change constraint may equal to the power change threshold ΔP_{Threhsold}, although in some embodiments these values may be different. For example, the power rate of change constraint C_{P} may be less than the power change threshold ΔP_{Threhsold}. In some examples, the power rate of change constraint may be configured to ensure that the work vehicle 120 does not exceed a maximum acceleration target.

Similar to the power change threshold ΔP_{Threhsold}, the same power rate of change constraint C_{P} may be applied for both increases and decreases in the magnitude of the proposed power output P_{Proposed 1}(t) relative to the magnitude of the current power output P Current(t). Alternatively, a power increase rate of change constraint C_{PInc} and a power decrease rate of change constraint C_{PDEc} may be applied for the respective scenarios. That is to say, in some embodiments:

$$\begin{matrix}if \vert {P}_{Proposed 1} ( t ) \vert > \vert {P}_{Current} ( t ) \vert , {C}_{P} = {C}_{Pinc} ; and \\ if \vert {P}_{Proposed 1} ( t ) \vert < \vert {P}_{Current} ( t ) \vert , {C}_{P} = {C}_{Pdec} .\end{matrix}$$

According to step 260 of method 200, the determined change in the torque output of the powertrain 124 may be updated based on the power rate of change constraint C_{P} in the following way.

Similar to the torque rate of change constraint, where the change in power output of the powertrain exceeds the power change threshold ΔP_{Threhsold}, the change in the power output of the powertrain ΔP is constrained by the power rate of change constraint of the appropriate sign.

That is to say, if ΔP(t)>ΔP_{Threhsold}.

$$\begin{matrix}Δ P ( t ) = {C}_{P} ; and \\ if Δ P ( t ) < - Δ {P}_{Threshold} : \\ Δ P ( t ) = - {C}_{P} .\end{matrix}$$

Once the change in power output ΔP(t) is calculated for step 260, the method may determine an associated change in the torque output of the powertrain. As such, the determined change in the torque output ΔT(t) of the powertrain may be updated based on ΔP(t).

$$That is to say : Δ T ( t ) = Δ P ( t ) / ω ( t )$$

where ω(t) is a speed of powertrain at timestep t.

In effect, the controller 122 may determine a second proposed torque output Y(t) for the powertrain 124 for timestep t:

$$Y ( t ) = {T}_{current} ( t ) + Δ P ( t ) / ω ( t )$$

In step 270, the controller 122 is configured to control the torque output of the powertrain 124 based on the determined change in the torque output (ΔT(t)). For example, the controller may determine the (new) torque output T(t) for the powertrain 124 the timestep t as:

$$T ( t ) = {T}_{current} ( t ) + Δ T ( t )$$

As such, the controller may effectively select either the first proposed torque output X(t) or the second proposed torque output Y(t) as the torque output T(t) for the powertrain 124, where the selection of X(t) or Y(t) depends on step 250 of method 200 ((i.e.—ΔP_{threshold}<ΔP<ΔP_{threshold}).

In this way, a determined change in the torque output may be based on the first proposed torque output and the current torque output in a first scenario where the conditions of the step 250 are not satisfied. As such, in the first scenario, the rate of change of the torque output of the powertrain 124 may be controlled based on the torque rate of change constraint. In a second scenario where the conditions of the step 250 are satisfied (i.e. the first proposed torque output causes an undesirable increase in power), the rate of change and/or the magnitude of the torque output of the powertrain 124 may be controlled based on the power rate of change constraint.

In some embodiments, in the third step 250, whether or not to apply the power rate of change constraint may be further conditioned on a power rate limit enable threshold. For example, in some embodiments, it may be desirable not apply to the power rate of change constraint when the work machine is operating at a relatively low power output. Thus, in some embodiments, as part of step 250, the method 200 may selectively apply the power rate of change constraint based on the magnitude of the proposed output power of the powertrain P_{Proposed 1}(t) and a power enable threshold P_{RLenable}. That is to say, if |P_{Proposed 1}(t)|<P_{RLenable}, the method may not perform steps 250, and 260 and may output the first proposed torque output X(t) as the torque output T(t) in step 270.

As will be appreciated by those skilled in the art, a work operation may correspond to a low or zero powertrain 124 speed. At zero or low powertrain 124 speeds, it may be desirable to allow the powertrain 124 to briefly provide a rate of change of torque which exceeds the power rate of change constraint C_{P}, in order to provide responsive torque (and power) while performing a digging operation. It will be appreciated that the low power exception to the power rate of change constraint may not result in excessive acceleration of the work vehicle, as any prolonged acceleration of the work vehicle 120 results in the power output of the powertrain 124 increasing, resulting in the proposed power output quickly exceeding the power enable threshold.

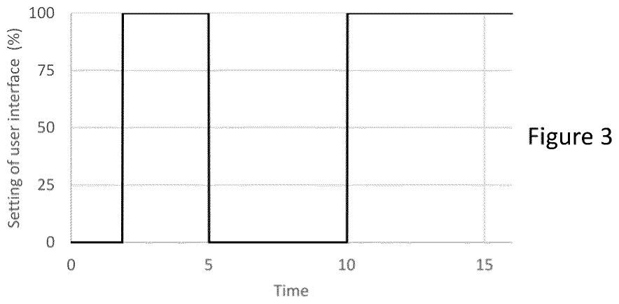

Next, operation of the controller 122 will be explained with reference to FIGS. 3 to 7, which show graphs of various controller parameters of a controller 122 varying over time. Specifically, FIGS. 3 to 7 show the work vehicle 120 first being demanded to perform a “work operation” over the time period of 2 to 5 seconds. During the work operation, a step change in the demanded torque output is made, but the power output of the powertrain does not increase significantly. Such a work operation may be representative of digging in a pile or pushing a heavy load for example. At a later time period (time 10 seconds to 17 seconds in FIGS. 3 to 7), the work vehicle 120 is demanded to perform a “driving operation” in which a further step change in the demanded torque output is made and the power output of the powertrain 124 increases relatively quickly as the work vehicle 120 accelerates.

FIG. 3 shows the variation of a user interface of the work machine for providing a torque input to a controller. As explained previously, a user may provide a demanded torque via a pedal, a lever, or any other such device for providing a demanded torque to the controller 122. In the example shown in FIG. 3, a first demand for torque is made between around 2 and 5 seconds by a user adjusting a user interface. A second demand for torque is made between around 10 and 17 seconds, again by adjusting the user interface. In the first demand for torque, the work machine 120 may be carrying out a work operation. In the second demand for torque the work machine may be carrying out a driving operation.

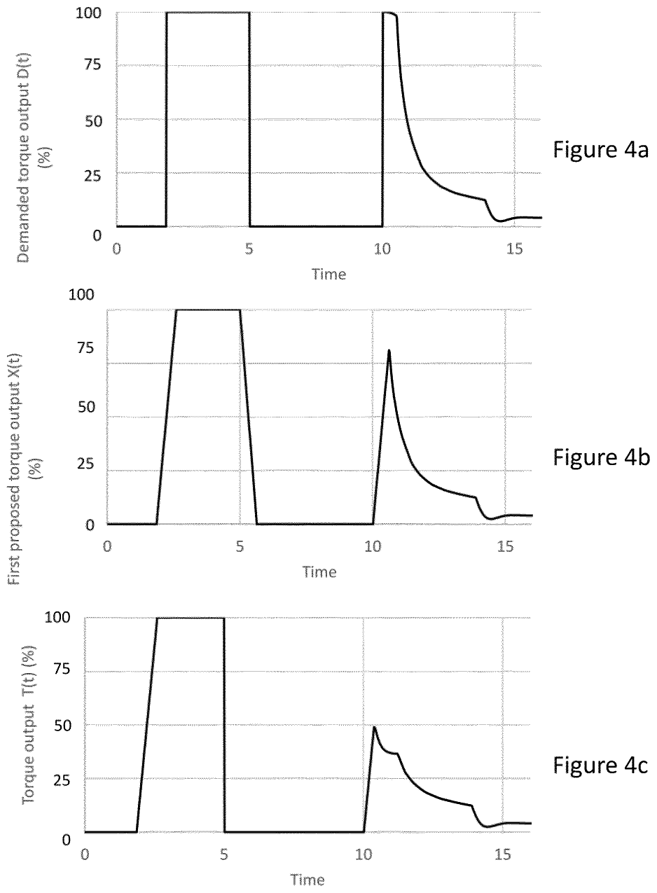

FIGS. 4a to 4c show the variation in the demanded torque output D(t), first proposed torque output X(t), and second proposed torque output Y(t) respectively over time in response to the user interface demand profile shown in FIG. 3.

FIG. 4a shows the variation of the demanded torque output D(t) with time. As will be appreciated, as a user adjusts a user interface, for example to control a speed of the work vehicle 120, the controller may determine a demanded torque output for the powertrain 124 in order to provide the desired performance requested by a user. The skilled person is familiar with Engine Control Units which are configured to determine a demanded torque output in response to a user interface demand. As shown in FIG. 4a, for the work operation, where the work vehicle 120 does not substantially accelerate, the demanded torque output remains relatively high for the duration of the work operation. For the driving operation, initially the demanded torque output determined by the controller is relatively high. As the work vehicle 120 accelerates towards the speed demanded by the user interface, the demanded torque output determined by the controller 122 reduces. At the end of both the work operation and the driving operation, the user interface demands that the work vehicle returns to rest. For the work operation, where the work vehicle 120 does not substantially accelerate, the controller thus determines that the demanded torque output returns instantaneously to zero. For the driving operation, the controller 122 determines a negative torque output is to be provided in order to slow the work vehicle 120 to rest.

FIG. 4b shows the variation of the first proposed torque output X(t) with time. As will be appreciated from the above description, the first proposed torque output X(t) is determined based on the torque rate of change constraint C_{T}. As such, in response to the step increases in demanded torque output (e.g. at 2 s and 10 s in FIG. 4b) the first proposed torque output increases a rate limited by the torque rate of change constraint C_{T}.

FIG. 4c shows the variation of the torque output of the powertrain 124 with time for work operation and the driving operation. At the start of the first work operation, the torque output T(t) increases in accordance with the first proposed torque output, as the power output of the powertrain 124 is negligible. That is to say, the torque output increases based on C_{T} which may be provided in order to meet a desired time to maximum torque output for a work operation. During the driving operation (i.e. from 10 seconds onwards), the torque output initially varies according to the first proposed torque output X(t), as the power output of the powertrain 124 is below a power enable threshold P_{RLenable}. For such relatively low power outputs, the rate of change of power output constraint is not applied, in accordance with the above description.

During the driving operation, once the power output of the powertrain 124 reaches the power enable threshold P_{RLenable}, the controller 122 is configured to check whether the first proposed power output causes an undesirable change in the power output of the powertrain. In such cases, the rate of change and/or the magnitude of the torque output is updated in accordance with the power rate of change constraint C_{P}. Thus, it will be appreciated that at around 11 seconds in FIG. 4c, the torque output T(t) is based on the second proposed torque output Y(t), which is lower than the first proposed torque output X(t). In this way, the torque output T(t) varies according to different proposed torque outputs depending on whether the work vehicle 120 is carrying out a work operation or a driving operation.

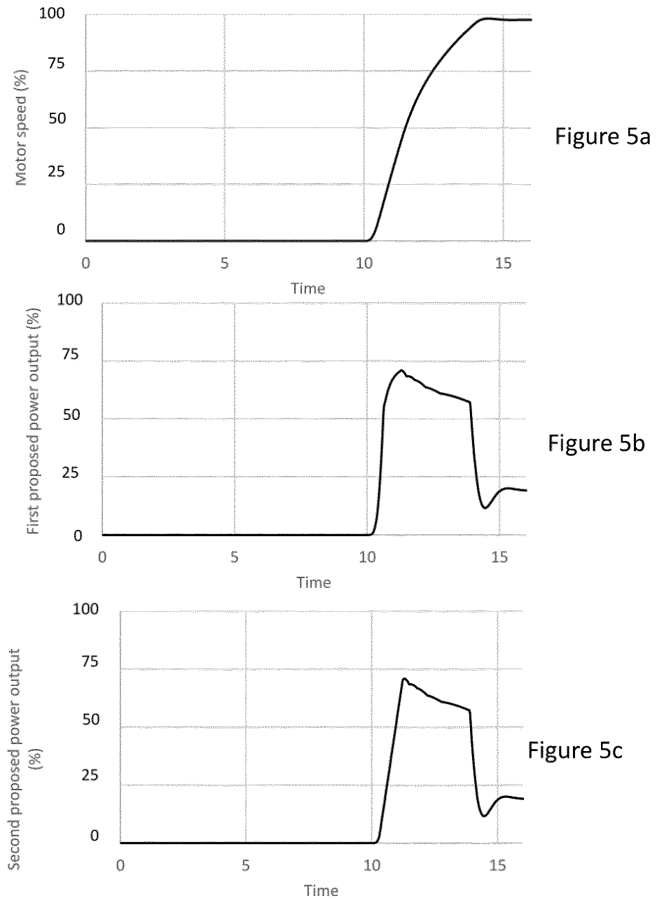

FIGS. 5a, 5b, and 5c show graphs of the variation in the powertrain speed ω(t), the first proposed power output P_{Proposed1}(t), and the second proposed power output P_{Proposed2}(t). It will be appreciated from FIG. 5a that the powertrain speed ω(t) for the work operation is negligible, and thus the power outputs shown in FIGS. 5b and 5c are also negligible.

As shown in FIG. 5a, for the driving operation the powertrain speed increases from 10 seconds. Thus, for the initial increase in power during the driving operation, the second proposed power output deviates from the first proposed power output, as will be appreciated from the above discussion. This deviation in proposed power output (i.e. the rate of change of the second proposed power output is constrained by the power rate of change constraint) gives rise to the difference between the first proposed torque output X(t) and the torque output T(T) in FIGS. 4b and 4c discussed above.

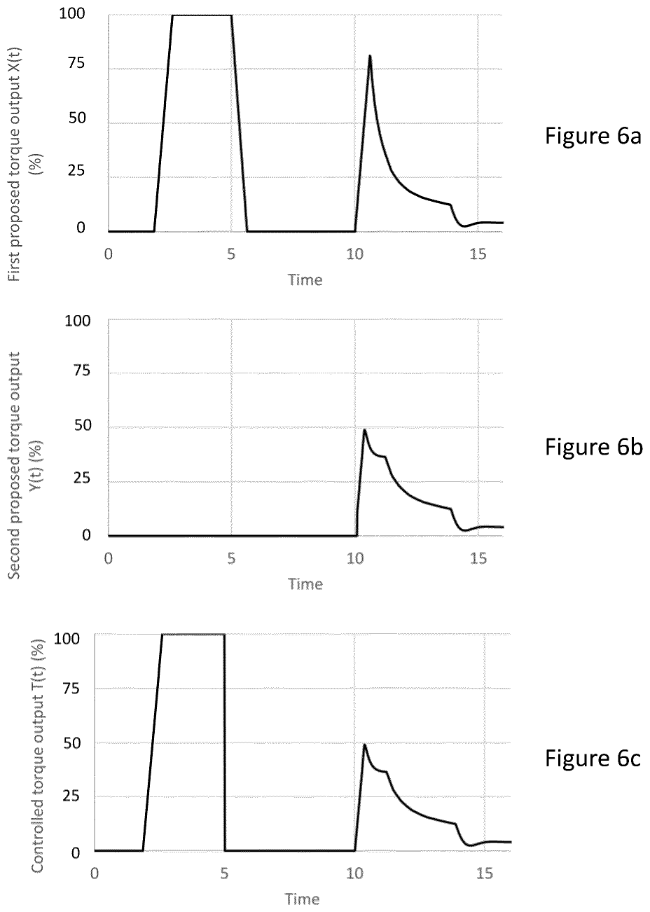

For completeness, FIGS. 6a, 6b and 6c show graphs of the first proposed torque output X(t), second proposed torque output Y(t), and the torque output T(t) for the powertrain 124 respectively in response to the work operation and the driving operation. By comparing FIGS. 6a and 6b with FIG. 6c, it will be appreciated where the controller 122 switches from torque-based control of the rate of change of torque to a power-based control of the rate of change and/or magnitude of the torque.

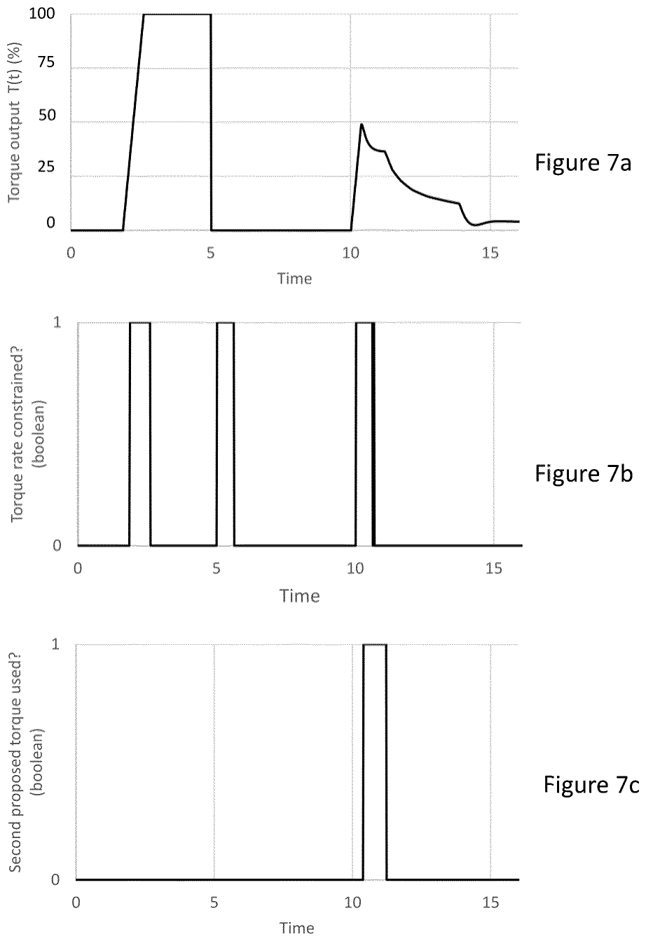

FIG. 7a shows a graph of the torque output T(t) of the powertrain which is calculated by the controller 122 as discussed above. FIG. 7b shows a graph indicating the periods of time where the demanded torque output of the powertrain D(t) exceeds a rate of change based on the torque rate of change constraint (C_{T}). As such, the logic value 1 in FIG. 7b indicates a period of time in which the rate of change of the torque output T(t) of the powertrain is limited at least by the torque rate of change constraint C_{T}. For example, as shown in FIG. 7b, the rate of change in the torque output is limited at the beginning and end of the work operation, and at the start of the driving operation (due to power output being below the power enable threshold). FIG. 7c shows a graph indicating the time periods where the rate of change in the torque output T(t) is limited by a power rate of change constraint C_{P}. As such, the logic value 1 in FIG. 7 indicates a period where the second proposed torque output is used as the torque output T(t) of the powertrain 124. In FIG. 7c, a logic value of 1 is used to indicate that the change in the torque output T(t) of the powertrain 124 is being limited by the power rate of change constraint C_{P}, rather than the torque rate of change constraint C_{T} (i.e. that the second proposed torque output Y(t) is used instead of the first proposed torque output X(t)).

It will be appreciated from FIGS. 7a, 7b, and 7c that where the torque output T(t) of the powertrain is changing at a rate below the power change threshold ΔP_{threshold} (e.g. at around 13 seconds or around 21 seconds), then the rate of change in the torque output changes in accordance with the desired torque output D(t).

FIG. 14 shows an evaluation of whether the first proposed power output exceeds the power rate limit enable threshold for the same operations as in FIGS. 3-13. As will be appreciated, in some embodiments, applying the power rate of change constraint is conditioned on the first proposed power output exceeding the power rate limit enable threshold. The y-axis takes a value of 1 if the first proposed power output exceeds the power rate limit enable threshold. The y-axis takes a value of 0 if the first proposed power output does not exceed the power rate limit enable threshold.

### INDUSTRIAL APPLICABILITY

This disclosure provides a method of controlling a work output of a work vehicle in response to a demanded torque output. A controller for a powertrain, a powertrain, and a work vehicle may also be provided which are each configured to perform the methods according to this disclosure.

As such, the methods according to this disclosure may be applicable to work vehicles 120 including internal combustion engine work vehicles and electric work vehicles.

According to this disclosure, a work vehicle may be tasked to perform a work operation or a driving operation. A driving operation may include using the mechanically powered components to move the work vehicle 120. The work operations may include pushing operations and/or pulling operations and/or digging operations.

As described above, the torque output requirements for driving operations may be different to the torque output requirements for work operations. For example, during a work operation relatively large changes in torque may be desired over a relatively short timescale in order to provide the desired functionality of the work vehicle.

While a maximum rate of change of torque may be provided for a work operation, such a maximum rate of change of torque may not be desirable for a driving operation. For example, a maximum rate of change of torque desirable for a work operation may result in excessive acceleration if when for a driving operation. Excessive acceleration of the work vehicle 120 may cause driver discomfort, and/or reduce the handling of the work vehicle 120. As such, for some other operations of a work vehicle 120, such as a driving operation, it may be desirable to provide a lower maximum rate of change and/or magnitude of torque, than the maximum rate of change and/or magnitude of torque allowable during a work operation.

According to the present disclosure, a method and a controller for a work vehicle are provided which controls a rate of change of a torque output of a powertrain in a manner which is suitable for both work operations and driving operations. As such, the method and controller may allow a rate of change of torque during a work operation which allows the work vehicle to meet a time to maximum torque output target for example. For a driving operation, where the method/controller determines that the rate of change of the power output of the powertrain is above a power change threshold, this may be indicative of a driving operation. To avoid or reduce e.g. excessive acceleration which may have resulted from the powertrain attempting to reach the time to maximum torque target suitable for a work operation, the method/controller may apply a power rate of change constraint when calculating the torque output for the powertrain.

Thus, the method and controller may calculate a torque output for a powertrain which is suitable for both a work operation and a driving operation.

1. A method of controlling a torque output of a powertrain of a work vehicle in response to a demanded torque output for the powertrain, the method comprising:
determining a change in the torque output of the powertrain in response to the demanded torque output based on a torque rate of change constraint;
determining a change in the power output of the powertrain based on the determined change in the torque output of the powertrain,
wherein if the determined change in the power output of the powertrain exceeds a power change threshold of the powertrain, the determined change in the torque output of the powertrain is updated based on a power rate of change constraint of the powertrain; and
controlling the torque output of the powertrain based on the determined change in the torque output.

2. A method according to claim 1, wherein
the demanded torque output is determined based on a user operating a power regulator of the work vehicle.

3. A method according to any of claim 1, wherein
the torque rate of change constraint is provided in order to meet a time to maximum torque target for the powertrain of the work vehicle.

4. A method according to claim 1, wherein
determining a change in the torque output of the powertrain in response to the demanded torque output comprises:
determining a first proposed torque output of the powertrain based on the torque rate of change constraint; and
converting the first proposed torque output of the powertrain into a first proposed power output of the powertrain based on a powertrain speed of the powertrain.

5. A method according to claim 1, wherein
the power rate of change constraint is configured to meet a maximum acceleration target.

6. A method according to claim 1, wherein
updating the determined change in torque output based on a power rate of change constraint of the powertrain comprises:
determining a second proposed power output of the powertrain based on the based on the power rate of change constraint; and
converting the second proposed power output of the powertrain into a second proposed torque output of the powertrain based on a powertrain speed of the powertrain.

7. A method according to claim 1, wherein
the change in torque output of the powertrain is determined based on a current torque output of the powertrain, the demanded torque output and the torque rate of change constraint.

8. A method according to claim 1, wherein
if the determined change in the power output of the powertrain exceeds a power change threshold of the powertrain and a proposed output power of the powertrain exceeds a power rate limit enable threshold, the determined change in the torque output of the powertrain is updated based on a power rate of change constraint of the powertrain,
wherein:
the proposed output power of the powertrain is determined based on a current power output of the powertrain and the determined change in the power output of the powertrain.

9. A method according to claim 1, wherein
where the magnitude of the demanded torque output increases relative to a magnitude of the current torque output of the powertrain, the change in the torque output of the powertrain is determined based on a torque increase rate of change constraint, and
where the magnitude of the demanded torque output decreases relative to a magnitude of the current torque output of the powertrain, the change in the torque output of the powertrain is determined based on a torque decrease rate of change constraint.

10. A method according to claim 1, wherein
where the magnitude of the demanded torque output increases relative to a magnitude of the current torque output of the powertrain, the power change threshold is a power change increase threshold; and
where the magnitude of the demanded torque output decreases relative to a magnitude of the current torque output of the powertrain, the power change threshold is a power change decrease threshold.

11. A method according to claim 1, wherein
where the magnitude of the demanded torque output increases relative to a magnitude of the current torque output of the powertrain, the power rate of change constraint is a power increase rate of change constraint; and
where the magnitude of the demanded torque output decreases relative to a magnitude of the current torque output of the powertrain, the power rate of change constraint is a power decrease rate of change constraint.

12. A method according to claim 1, wherein
the change in the torque output of the powertrain is determined for a timestep of a predetermined duration.

13. A method according to claim 1, wherein
the power rate of change constraint is based on the power change threshold.

14. A controller for controlling a torque output of a powertrain of a work vehicle, the controller configured to:
obtain a demanded torque output for the powertrain;
determine a change in the torque output of the powertrain in response to the demanded torque output based on a torque rate of change constraint;
determine a change in the power output of the powertrain based on the determined change in the torque output of the powertrain,
wherein if the determined change in the power output of the powertrain exceeds a power change threshold of the powertrain, the controller is configured to update the
determined change in the torque output of the powertrain based on a power rate of change constraint of the powertrain; and
output a signal for controlling the torque output of the powertrain based on the determined change in the torque output.

15. A powertrain for a work vehicle, the powertrain configured to receive the signal output from the controller of claim 14 for controlling the torque output of the powertrain.

16. A work vehicle comprising a controller according to claim 14 and a powertrain configured to receive the signal output from the controller for controlling the torque output of the powertrain.

17. A computer program comprising instructions to cause the controller of claim 14 to perform a method comprising:
determining a change in the torque output of the powertrain in response to the demanded torque output based on a torque rate of change constraint;
determining a change in the power output of the powertrain based on the determined change in the torque output of the powertrain,
wherein if the determined change in the power output of the powertrain exceeds a power change threshold of the powertrain, the determined change in the torque output of the powertrain is updated based on a power rate of change constraint of the powertrain; and
controlling the torque output of the powertrain based on the determined change in the torque output.

18. A computer-readable medium having stored thereon the computer program of claim 17.
